(19) United States
(12) Patent Application Publication
(10) Pub. No.: US 2023/0093100 A1
(43) Pub. Date: Mar. 23, 2023

(54) FLUID SUPPLY APPARATUS FOR INDUCING CAVITATION AND COANDA EFFECTS

(71) Applicants: Jun ll YOU, Busan (KR); Jung Hoon CHOI, Gimpo-si, Gyeonggi-do (KR)

(72) Inventors: Jun Il YOU, Busan (KR); Jung Hoon CHOI, Gimpo-si, Gyeonggi-do (KR); Yong Bae KIM, Gumi-si, Gyeongsangbuk-do (KR)

(73) Assignees: Jun Il YOU, Busan (KR); Jung Hoon CHOI, Gimpo-si, Gyeonggi-do (KR)

(21) Appl. No.: 17/800,367

(22) PCT Filed: Feb. 18, 2021
(86) PCT No.: PCT/KR2021/002084

§ 371 Date: Aug. 17, 2022

(30) Foreign Application Priority Data
Feb. 20, 2020 (KR) 10-2020-0020954
Feb. 25, 2020 (KR) 10-2020-0023020
Apr. 27, 2020 (KR) 10-2020-0050872
Apr. 27, 2020 (KR) 10-2020-0050878
Feb. 24, 2021 (KR) 10-2021-0016295

(51) Int. Cl. B05B 1/34

(52) U.S. Cl. CPC B05B 1/341

(57) ABSTRACT

A fluid supply apparatus for inducing cavitation and Coanda effects, includes: a cavitation generator configured to allow an introduced fluid to flow while rotating along a propeller-shaped wing so as to generate microbubbles in the fluid; and a Coanda generator disposed in front of the cavitation generator and having a plurality of Coanda generating protrusions arranged at regular distances so that, as a fluid passing through the cavitation generator to contain microbubbles passes through a passage between the Coanda generating protrusions, a velocity increases and the pressure decreases, thereby causing a Coanda effect in which the fluid flows along a surface of an object.

### CROSS-REFERENCE TO PRIOR APPLICATIONS

This application is a National Stage Patent Application of PCT International Patent Application No. PCT/KR2021/002084 (filed on Feb. 18, 2021) under 35 U.S.C. § 371, which claims priority to Korean Patent Application Nos. 10-2020-0020954 (filed on Feb. 20, 2020), 10-2020-0023020 (filed on Feb. 25, 2020), 10-2020-0050872 (filed on Apr. 27, 2020), 10-2020-0050878 (filed on Apr. 27, 2020), and 10-2021-0016295 (filed on Feb. 4, 2021), which are all hereby incorporated by reference in their entirety.

### BACKGROUND

The present disclosure relates to a fluid supply apparatus, and more particularly, to a fluid supply apparatus for inducing cavitation and Coanda effects.

If a fluid is supplied to a surface of an object to be processed by a machining apparatus, the temperature of the object to be processed is lowered and lubricity is improved, thereby improving the productivity of the machining apparatus.

However, even if a high pressure exceeding a certain level or a large amount of fluid is supplied to the surface of the object to be processed, productivity is not improved proportionally.

### SUMMARY

Accordingly, the present disclosure has been proposed in consideration of the above matters, and the present disclosure is to provide a fluid supply apparatus capable of reducing a temperature of an object to be processed and improving a lubrication effect through a fluid supplied to a surface of an object to be processed.

In addition, the present disclosure is to provide a fluid supply apparatus capable of improving production efficiency of the fluid supply apparatus as described above.

A fluid supply apparatus for inducing cavitation and Coanda effects according to an embodiment of the present disclosure includes: a cavitation generator (100) configured to allow an introduced fluid to flow while rotating along a propeller-shaped wing so as to generate microbubbles in the fluid; and a Coanda generator (200) disposed in front of the cavitation generator (100) and having a plurality of Coanda generating protrusions (210) arranged at regular distances so that, as a fluid passing through the cavitation generator (100) to contain microbubbles passes through a passage between the Coanda generating protrusions (210), a velocity increases and the pressure decreases, thereby causing a Coanda effect in which the fluid flows along a surface of an object, wherein each of the Coanda generating protrusions (210) has a rhombic cross section, and a length (L2) of a transverse central axis of each of the Coanda generating protrusions (210) is 25% to 35% of a length (L1) of a longitudinal central axis, wherein a direction parallel to the longitudinal central axis of each of the Coanda generating protrusions 210 is defined as an x direction, a direction orthogonal to the x direction and parallel to the transverse central axis of each of the Coanda generating protrusions 210 is defined as a y direction, and a direction parallel to any one hypotenuse of each of the Coanda generating protrusions (210) is defined as a z direction, a distance (D1) between Coanda generating protrusions (210) In the y-direction is formed at a ratio of 22% to 30% of the longitudinal central axis length L1, and a distance D2 between Coanda generating protrusions (210) in the z direction is formed at a ratio of 36% to 59% of the length (L1) of the longitudinal central axis.

A fluid supply apparatus for inducing cavitation and Coanda effects according to an embodiment of the present disclosure includes: a cavitation generator configured to allow an introduced fluid to flow while rotating along a propeller-shaped wing so as to generate microbubbles in the fluid; a Coanda generator disposed at a rear end of the cavitation generator and configured to allow a velocity to increase as a fluid passing through the cavitation generator to contain microbubbles passes through a passage between the Coanda generating protrusions and to allow the fluid to be discharged through an inclined surface of a fluid supply part so as to reduce pressure of the fluid, thereby causing a Coanda effect in which the fluid flows along a surface of an object; and a first fluid diffusion part configured to allow the fluid, which is introduced to increase a velocity of the fluid passing through the cavitation generator, to pass through a central portion of the cavitation generator and be injected toward an outer circumferential surface of the cavitation generator.

In a fluid supply apparatus according to the present disclosure, there is an effect that microbubbles are generated in a fluid supplied to a surface of an object due to a cavitation effect and the microbubbles generated in this way flow along the surface of the object to be processed due to a Coanda effect, thereby improving a surface temperature and lubricity of the object to be processed.

In particular, in the fluid supply apparatus of the present disclosure, there is an effect that a part of the fluid introduced into a cavitation generator is injected to an outer circumferential surface of a Coanda generator through a second fluid diffusion part to further increase a velocity of the fluid flowing to the outer circumferential surface of the Coanda generator, thereby further improving a Coanda effect on a surface of the Coanda generator.

In addition, in the fluid supply apparatus according to the present disclosure, there is an effect that a Coanda generating protrusion has a rhombus shape and vertices and hypotenuses of the rhombuses are located on the same line with each other, thereby maximizing generation of a Coanda effect and enabling easy processing.

In the fluid supply apparatus according to another aspect of the present disclosure, the cavitation generator is supported as if being buoyed by the Coanda generator through a fluid, and thus, the fluid supply apparatus can be used semi-permanently and can be prevented from direct contact between the cavitation generator and the Coanda generator even in the event of external shock, preventing product damage.

### BRIEF DESCRIPTION OF THE DRAWINGS

FIG. 1 is an exploded view showing a configuration of a fluid injection device to which a fluid supply apparatus according to the present disclosure is applied.

FIG. 2 is a perspective view showing a form of a fluid supply apparatus according to a first embodiment of the present disclosure.

FIG. 3 is a perspective view showing a shape of a rear end of a fluid supply apparatus according to the first embodiment of the present disclosure.

FIG. 4 is a reference diagram illustrating an internal structure of a fluid supply apparatus according to the first embodiment of the present disclosure.

FIGS. 5 to 7 are reference views illustrating shapes of Coanda generating protrusions applied to a fluid supply apparatus according to embodiments of the present disclosure.

FIG. 8 is a graph illustrating flow velocity and pressure measurement results of embodiments depending on shapes of Coanda generating protrusions applied to a fluid supply apparatus according to embodiments of the present disclosure.

FIGS. 9 to 10 are reference views showing a shape of a fluid supply apparatus according to a second embodiment of the present disclosure.

FIG. 11 is a reference view showing a shape of a fluid bearing applied to the fluid supply apparatus according to FIGS. 9 to 10.

FIG. 12 is a reference view showing a form of a fluid supply apparatus according to a third embodiment of the present disclosure.

FIG. 13 is a reference view showing a form of a fluid supply apparatus according to a fourth embodiment of the present disclosure.

FIG. 14 is a reference view showing a form of a fluid supply apparatus according to a fifth embodiment of the present disclosure.

FIG. 15 is a reference view showing a form of a fluid supply apparatus according to a sixth embodiment of the present disclosure.

FIG. 16 is a reference view showing a form of a fluid supply apparatus according to a seventh embodiment of the present disclosure.

FIG. 17 is a reference view showing a form of a fluid supply apparatus according to an eighth embodiment of the present disclosure.

### DETAILED DESCRIPTION

Prior to describing the embodiments according to the present disclosure in detail, the present disclosure is not limited to the configurations shown in the following detailed description or the accompanying drawings, which may be used or implemented in various ways.

It is also to be understood that the expressions or terms used in the present specification are merely for explanation and should not be regarded as limiting the scope of the present disclosure.

That is, in the present specification, the expressions “mounted,” “installed,” “accessed,” “connected,” “supported,” “coupled,” etc. are used as broad expressions including both direct and indirect mounting, installation, access, connection, support, and coupling. The expressions “accessed”, “connected”, “coupled” are not limited to physical or mechanical access, connection, or coupling.

And in the present specification, the terms indicating directions such as upper, lower, downward, upward, rearward, bottom, front, rear, etc. are used to describe the drawings, but these terms are used to indicate relative directions (normally viewed) in the drawings for convenience of explanation. These directional terms should not be understood as limiting or restricting the present disclosure.

In addition, the terms such as “first”, “second”, “third”, etc. used in the present specification are for illustrative purposes only and should not be construed as implying a relative importance.

Hereinafter, embodiments of the present disclosure will be described in detail with reference to the accompanying drawings.

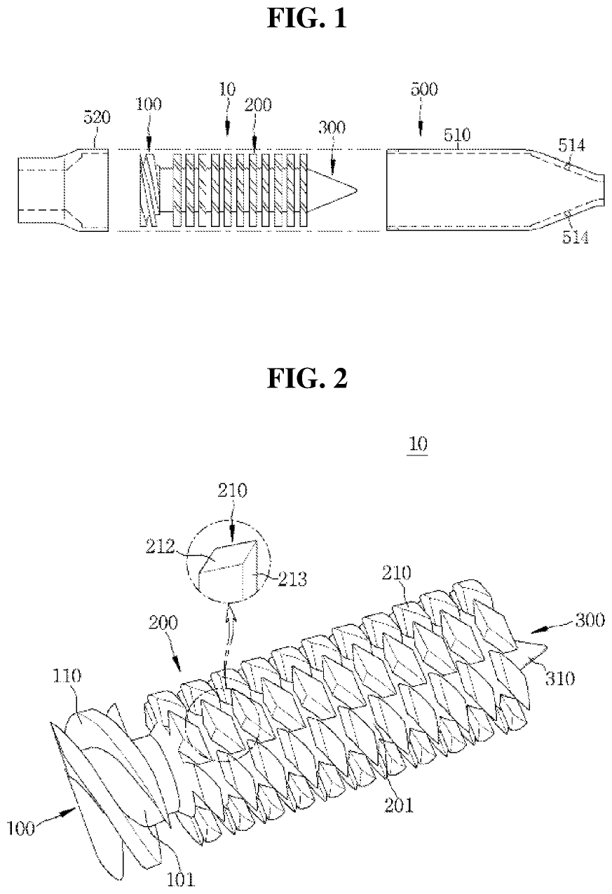

FIG. 1 is an exploded view showing a fluid injection device to which a fluid supply apparatus 10 for inducing cavitation and the Coanda effect according to a first embodiment of the present disclosure (hereinafter, referred to as a “fluid supply apparatus”) is applied, and the fluid injection device includes: an outer case 500 including a rear case 520 and a front case 510, which are capable of being fastened to each other; and the fluid supply apparatus 10 of the present invention, which is installed inside the outer case 500 to induce cavitation and the Coanda effect of a fluid supplied to a rear end of the outer case 500.

The rear case 520 and the front case 510 have a shape corresponding to the fluid supply apparatus 10 so as to accommodate the fluid supply apparatus 10 therein and are formed in a hollow shape. A rear end of the rear case 520 forms an inlet through which a fluid is introduced, and a front end of the front case 510 forms an outlet through which a fluid passing through the fluid supply apparatus 10 is discharged.

In addition, a plurality of external fluid input ports 514 may be formed to pass through a front portion of the front case 510. The external fluid input port 514 may be in the shape of a through hole passing through the front case 510 and may be configured to increase generation of a vortex and turbulence by introducing a fluid from the outside into the front part of the fluid supply apparatus.

Referring to FIGS. 2 to 4, the fluid supply apparatus 10 according to the first embodiment of the present disclosure includes a cavitation generator 100 and a Coanda generator 200.

The cavitation generator 100 causes a fluid to contain microbubbles through a cavitation effect, and the Coanda generator 200 causes a fluid containing microbubbles through a Coanda effect to have various shapes, such as a circle, on a surface of an object to be processed, thereby maximizing effects such as temperature reduction and lubricity of the object to be processed.

First, the cavitation generator 100 is provided with a cylindrical body 101, as shown in FIGS. 2 to 4, and a plurality of wings 110 is formed at a predetermined distance along a circumference of the body 101. In addition, in order to increase the amount of microbubbles generated by cavitation, the body 101 and a rear side 102 of the cavitation generator 100 are formed in the shape of a groove concave forward. The groove shape of the rear side 102 may be any of various groove shapes, such as a dome shape or a cone shape, a groove shape in which an edge is tapered edge and an inner surface is flat. In addition, the entire rear side 102 may be a flat plane.

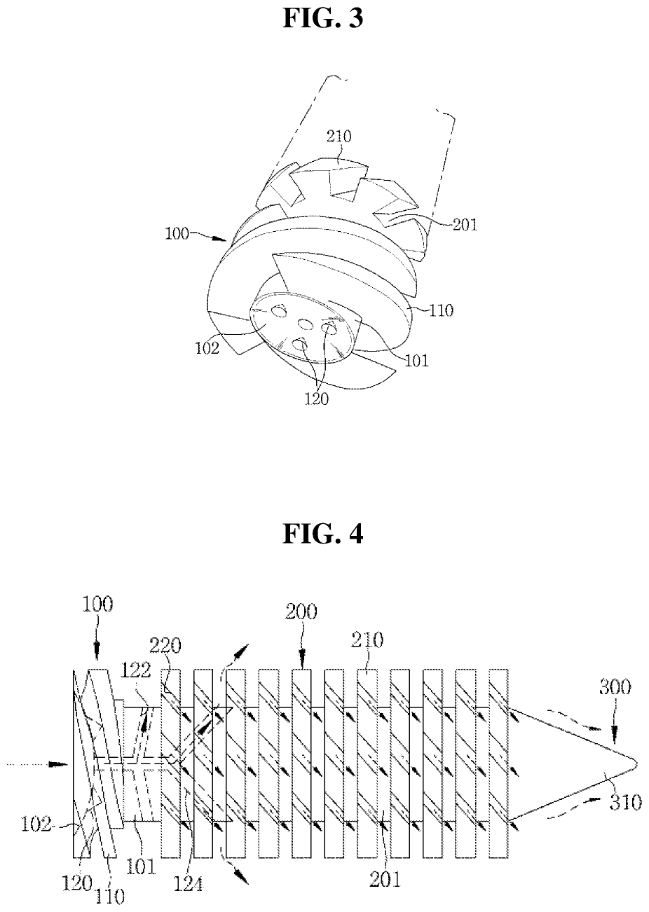

In addition, on a surface of the rear side 102 of the cavitation generator 100, a plurality of triangular groove-shaped turbulence generators 120 is formed at regular distances along a circumference of a center thereof in a circumferential direction. As such, as the turbulence generators 120 are formed at a rear end of the cavitation generator 100, a fluid supplied to the cavitation generator 100 collides with the concave groove-shaped rear side or flows into the triangular groove-shaped turbulence generators 120 and then returns and mixes, thereby further improving the effect of generating turbulence and vortex at the rear end of the cavitation generator 100. The shape of the turbulence generators 120 may be freely implemented according to a user's selection, in addition to triangular groove shape shown in FIGS. 3 and 4.

The wings 110 are formed in the shape of a propeller along a circumference of the cylindrical body 101, and the propeller shape is such that the propeller wings are thick and at a small angle of attack, as shown in FIGS. 2 and 3. In doing so, a bubble cavitation phenomenon in which microbubbles are generated near maximum thickness positions of the wings 110 is induced to occur.

Therefore, the microbubbles generated through the cavitation phenomenon are supplied to a surface of an object to be processed and generate micro-vibrations on the surface of the object to be processed so as to remove foreign substances generated on the surface of the object to be processed, thereby improving lubricity of the object to be processed.

Next, the rear end of the cavitation generator 100 has a flat surface as if it is cut, as shown in FIG. 3. This is to cause a fluid supplied to the cavitation generator 100 to collide with the flat surface to generate turbulence and vortex. As described above, when turbulence and vortex are generated at the rear end of the cavitation generator 100, the cavitation generated in the wings 110 occurs more so as to increase an amount of microbubbles generated.

In addition, a first fluid diffusion part 122 is formed in the center of the rear side 122 of the cavitation generator 100.

In addition, a first fluid diffusion part 122 is formed at the rear end of the cavitation generator 100. The first fluid diffusion part 122 extends forward from the center of the rear end of the cavitation generator 100 and then radially extends to communicate through an outer circumferential surface of the body 101, thereby increasing a velocity of fluid.

That is, a velocity of fluid passing through the cavitation generator 100 may be decreased due to resistance at flat rear ends or the wings 110, and when the velocity is decreased this way, a Coanda effect may be generated less by the Coanda generator 200 or a supply rate of fluid to an object to be processed may be reduced, thereby reducing the lubrication effect.

Accordingly, as shown in FIG. 4, a fluid is diffused by the first fluid diffusion part 122 to pass through the center of the cavitation generator 100 having a highest flow velocity without significant resistance and be then directly sprayed onto the outer circumferential surface of the cylindrical body 101, so that the fluid meets a fluid passing through the flat rear end of the cavitation generator 100 or the wings 110, thereby increasing a velocity.

The first fluid diffusion part 122 may be implemented according to a user's selection, such as a shape to further increase a velocity or to further increase pressure, in addition to the shape shown in FIG. 4. That is, the first fluid diffusion part 122 may be implemented in various forms, for example by making the size of an outlet smaller than that of an inlet or vice versa, or by changing a cross-sectional area of an internal pipe.

The surface of the cavitation generator 100 may be coated with nanofibers. The nanofibers refer to ultrafine threads each having a diameter of only several tens to several hundreds of nanometers, and when the surface is coated with the nanofibers, the effect of generating turbulence and vortex is further improved.

Next, the Coanda generator 200 will be described, and, as shown in FIG. 2, in the Coanda generator 200, a plurality of Coanda generating protrusions 210 is arranged at a predetermined distance along a circumference of the cylindrical Coanda body 201.

The Coanda effect refers to an effect in which a rapidly jetted fluid flows into an object when meeting the object, and when the Coanda effect occurs in a lubricating fluid injected into a processing fluid, the lubricating fluid flows while adhering closely to a surface of an object to be processed having any of various shapes and grooves, thereby maximizing the lubrication effect.

The present disclosure induces the Coanda effect to occur in a fluid by causing the fluid to pass through the Coanda generating protrusions 210 so as to rapidly accelerate the fluid.

In addition, the microbubbles generated through the cavitation phenomenon collide with the Coanda generating protrusions 210 and are divided into smaller microbubbles, thereby increasing an amount of microbubbles generated and improving the Coanda effect due to the microbubbles.

As shown in FIG. 4, a second fluid diffusion part 124 is formed in the Coanda generator 200.

The second fluid diffusion part 124 is a fluid passage passing through the outer circumferential surface of the Coranda body 201 from the center of the Coranda body 201, and the second fluid diffusion part 124 is formed such that a rear end of the second fluid diffusion part 124 communicates with a front end of the first fluid diffusion part 122 and is radially branched and extends from the center of the Coanda body 201, so that a front end of the second fluid diffusion part 124 passes through the outer circumferential surface of the Coanda body 201. Therefore, a part of the fluid introduced into the first fluid diffusion part 122 is smoothly diffused to the outside of the cylindrical Coanda body 201 through the second fluid diffusion part 124 to further increase a velocity of the fluid flowing along the outer surface of the Coanda body 201, thereby further enhancing the Coanda effect.

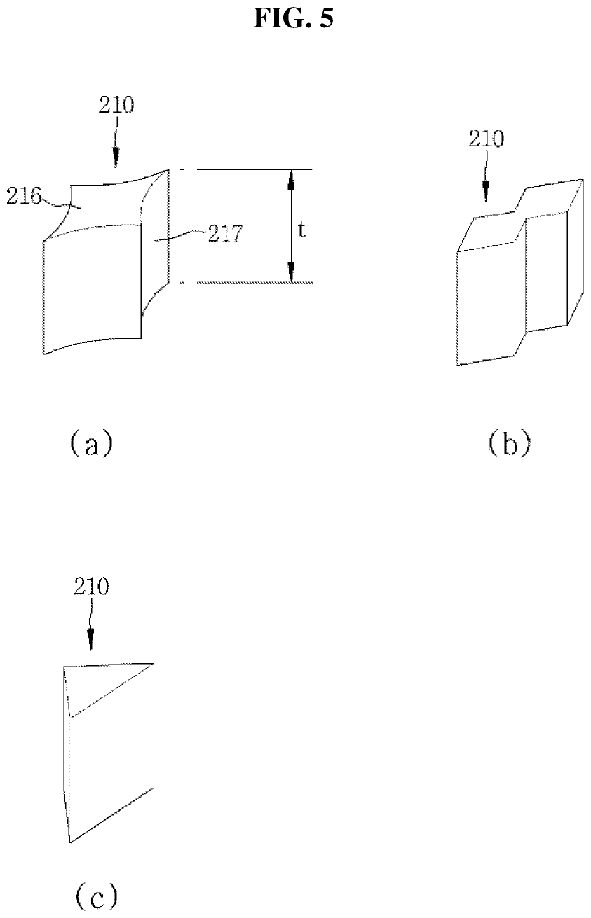

As shown in FIG. 2, the Coanda generating protrusion 210 may be freely implemented according to a user's selection, such as a rhombus shape in which both an upper surface 212 and a side surface 213 are flat as shown in FIG. 2, a rhombus shape in which an upper surface thereof is of a rhombus shape formed to be curved with the same curvature as a curvature of the Coanda body 201, a rhombus shape in which a side surface 217 is a curved surface having a predetermined curvature as shown in (a) of FIG. 5, an angled figure-of-8-shaped rhombus with a plurality of continuous rhombus shapes as shown in (b) of FIG. 5, a triangular pole shape as shown in (c) of FIG. 5, or the like.

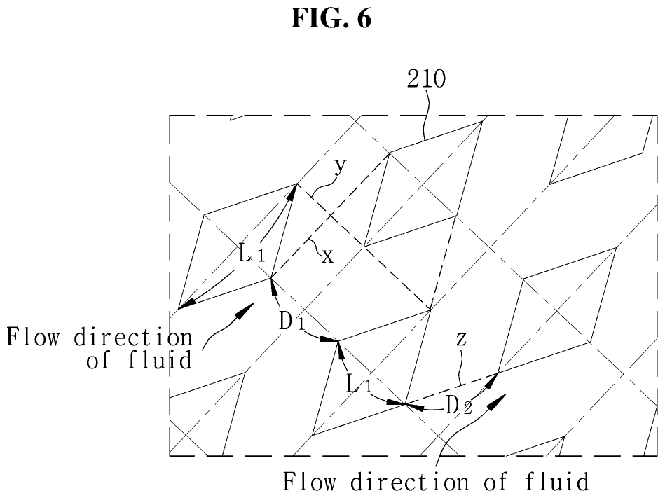

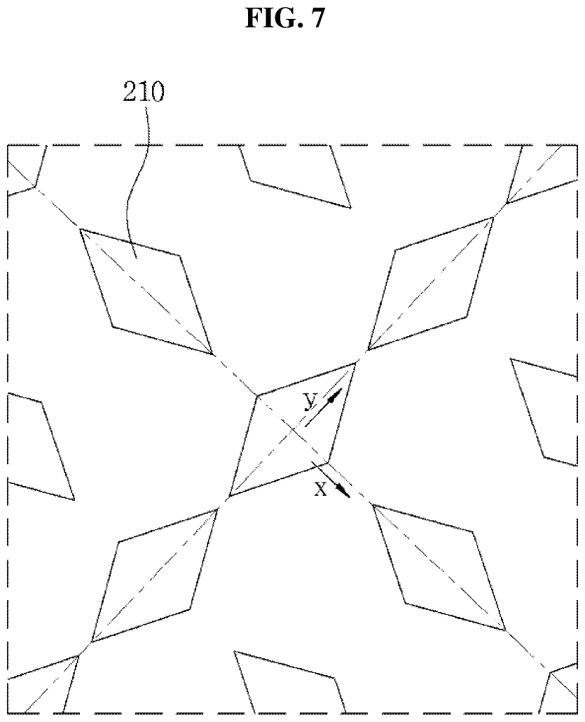

In addition, the arrangement of the Coanda generating protrusions 210 may be freely implemented according to a user's selection, for example, in a way that the Coanda generating protrusions 210 are arranged on the same line and in the same direction along the circumference of the cylindrical Coanda body 201, as shown in FIG. 6, or the Coanda generating protrusions 210 form a right angle to each other as shown in FIG. 7.

The Coanda generating protrusions 210 according to a preferred embodiment of the present disclosure have rhombus shapes as shown in FIG. 6, the vertices of the rhombuses are located on the same line in the x and y directions, and the hypotenuses of the rhombuses are located on the same line z. Here, the x direction is a direction parallel to a longitudinal central axis of a Coanda generating protrusion 210, and the y direction is a direction orthogonal to the x direction and parallel to a lateral central axis of the Coanda generating protrusion 210, and the z direction is a direction parallel to any one hypotenuse of the Coanda generating protrusion 210.

The following is an experimental example for various embodiments, in which a cutting tool is machined by supplying a lubricating fluid through the various embodiments under the same conditions (a supply amount of lubricating fluid, a supply speed, pressure, a state of the processing tool state, etc.) and it is found that a highest production (number of processed units) is exhibited when each Coanda generated protrusion 210 has a rhombus shape, vertices of the rhombus are located on the same line in the x and y directions, and hypotenuses of the rhombus are located on the same line (z) with each other (see FIG. 6).

TABLE 1

| | | Inner | | |
|---|---|---|---|---|
| | Rhombus | curvature | Angled figure- | Triangular |
| Classification | shape | rhombus | of-8 shape | pole shape |
| Located on the | 120 | 112 | 108 | 113 |
| same line | | | | |
| Positioned | 108 | 101 | 97 | 105 |
| orthogonal | | | | |

As such, when each Coanda generated protrusion 210 has a rhombus shape, vertices of the rhombus are located on the same line in the x and y directions, the hypotenuses of the rhombus are located on the same line (z) with each other, and hypotenuses of the rhombuses are located on the same line (Z), it is easy to process of the fluid supply apparatus 10, thereby further improving production efficiency. The distance between the Coanda generating protrusions 210 may be larger in a direction toward the rear end of the Coanda generating unit 200, thereby maximizing the Coanda effect.

As shown in FIG. 6, the Coanda generating protrusions 210 are preferably configured such that, with reference to a length L1 of the longitudinal central axis, a length L2 of a transverse central axis is formed in a proportion of 25% to 35% of the length L1 of the longitudinal central axis, a distance D1 between Coanda generating protrusions 210 in the y-direction is formed in a ratio of 22% to 30% of the length L1 of the longitudinal central axis, and a distance D2 between Coanda generating protrusions 210 in the z direction is formed at a ratio of 36% to 59% of the length L1 of the longitudinal central axis. In addition, a height t of the Coanda generating protrusions 210 (see FIG. 5) is preferably 32% to 55% of the length L1 of the longitudinal central axis.

Due to the ratio as described above, it is found that a velocity increases toward a downstream side (a front portion) of the Coanda generating protrusion 210, thereby improving the Coanda effect.

When the distances D1 and D2 between the Coanda generating protrusions 210 exceed the above-described ratio, a spacing between flow paths becomes too wide and thus a velocity is decreased, thereby reducing the Coanda effect, and when the distances D1 and D2 between the Coanda generating protrusions 210 are narrowed to less than the above ratio, the pressure increases, so that the microbubbles merge with each other as the pressure increases, thereby reducing an amount of bubbles generated.

Various examples of fluid supply apparatus (see Table 2) are provided by varying the length L1 of the longitudinal central axis of the Coanda generating protrusions 210, the length L2 of the transverse central axis, the distance D1 between Coanda generating protrusions 210 in the y direction, and the distance D2 between Coanda generating protrusions 210 in the z direction, and a fluid (cutting oil) is supplied at a constant velocity to a fluid injection device, which is equipped with each of the fluid supply apparatuses provided in the examples, to measure pressure and a velocity of the cutting oil discharged through an outlet of the fluid injection device so as to check the performance of the fluid supply device. The velocity of the fluid being supplied to an inlet of the fluid injection device is 7 m/s, and a diameter of the outlet of the fluid ejector is 6.5 mm.

TABLE 2

| | Example | Example | Example | Example | Example | Example | Example |
|---|---|---|---|---|---|---|---|
| Classification | 1 | 2 | 3 | 4 | 5 | 6 | 7 |
| Length L1 | 9.8890 | 9.8890 | 9.8890 | 16.1812 | 16.1812 | 16.1812 | 16.1812 |
| (mm) of | | | | | | | |
| longitudinal | | | | | | | |
| central axis | | | | | | | |
| Length L2 | 2.8857 | 2.8857 | 2.8857 | 2.8857 | 4.3485 | 4.3485 | 3.3880 |
| (mm) of | | | | | | | |
| transverse | | | | | | | |
| central axis | | | | | | | |
| Distance D1 | 3.6131 | 3.2118 | 3.0051 | 3.6131 | 3.6131 | 3.3910 | 3.2118 |
| (mm) in the y | | | | | | | |
| direction | | | | | | | |
| Distance D2 | 6.1650 | 5.9122 | 5.8939 | 5.9122 | 6.1650 | 5.9122 | 5.8939 |
| (mm) in the z | | | | | | | |
| direction | | | | | | | |
| Height (mm) | 5.7 | 5.5 | 5.5 | 5.8 | 6.7 | 6.8 | 7.0 |

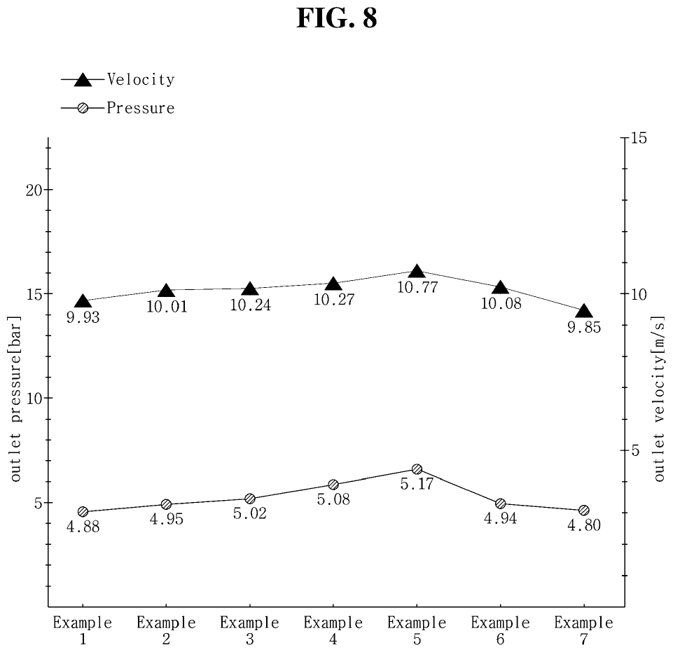

FIG. 8 is a graph showing changes in velocities and pressures for the fluid supply apparatuses of Examples 1 to 7 in Table 2, and as can be seen through this graph, in the case of Examples 3, 4, and 5, the velocity exceeded 10.20 m/s and the pressure also has a largest value of 5.0 bar or more. That is, in the case of Example 3, the distance D1 between Coanda generating protrusions 210 in the y direction is approximately 30% of the length L1 of longitudinal central axis of the Coanda generating protrusions 210, and the distance D2 between Coanda generated protrusions 210 in the z direction is approximately 59% of the length L1 of the longitudinal central axis.

In addition, in Example 4, the distance D1 between Coanda-generating protrusions 210 in the y direction is approximately 22% of the length L1 of the longitudinal central axis of the Coanda-generating protrusions 210, and the distance D2 between Coanda-generating protrusions 210 in the z direction is 36%. In Example 5, the distance D1 between Coanda-generating protrusions 210 in the y-direction is approximately 22% of the length L1 of the longitudinal central axis of the Coanda-generating protrusions 210, and the distance D2 between Coanda-generating protrusions 210 in the z direction is 38%.

Therefore, based on Examples 3, 4, and 5 with the largest velocity and pressure, it is preferable that the length L2 transverse central axis is 25% to 35% of the length L1 of the longitudinal central axis, the distance between Coanda generating protrusions 210 in the y direction is 22% to 30% of the length L1 of the longitudinal central axis, and the distance D2 between Coanda generating protrusions 210 in the z direction is 36% to 59% of the length L1 of the longitudinal central axis.

In addition, a height t of each of the Coanda generating protrusions 210 in Examples 3, 4, and 5 is 55%, 36%, and 41% of the length L1 of the longitudinal central axis.

Meanwhile, the fluid supply part 300 is provided in the front part of the Coanda generator 200, and in the fluid supply part 300, a fluid passing through the Coanda generating protrusions 210 is reduced in pressure while passing through the fluid supply part 300 of a conical shape so as to contain microbubbles and generate the Coanda effect, so that the fluid can be discharged with a maximized Coanda effect.

To this end, the fluid supply part 300 has a pointed cone shape toward a front end thereof, and a shape of an inner circumferential surface of a rear end of the outer case 500 (see FIG. 1) also has a conical shape corresponding thereto.

The fluid supply apparatus 10 according to the first embodiment of the present disclosure greatly improves the lubrication effect of a fluid supplied through the above-described configuration.

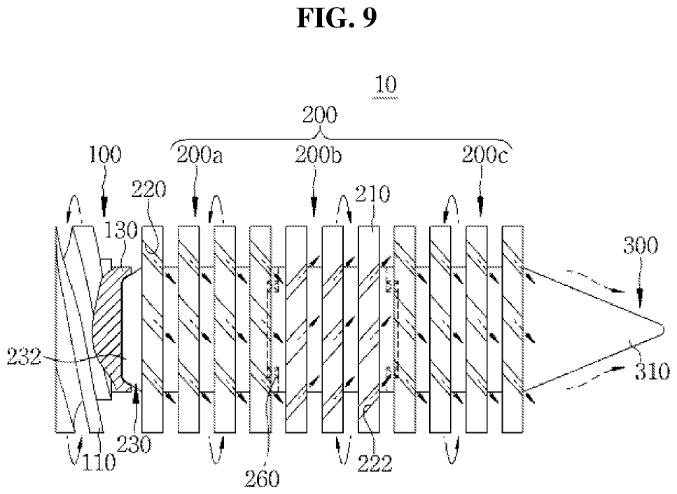

Hereinafter, a fluid supply apparatus 10 according to a second embodiment of the present disclosure will be described with reference to FIG. 9.

The fluid supply apparatus 10 according to the second embodiment of the present disclosure is different from the fluid supply apparatus 10 of the first embodiment in that a cavitation generator 100 and a Coanda generator 200 are separated from each other and that the cavitation generator 100 is relatively rotatable through fluid bearings.

That is, a rear end of the cavitation generator 100 forms an outer fluid bearing part 130, and a rear end of the Coanda generator 200 forms an inner fluid bearing part 230 to be inserted into the outer fluid bearing part 130.

Accordingly, as shown in FIG. 9, a fluid is introduced between an inner circumferential surface of the outer fluid bearing part 130 and an outer circumferential surface of the inner fluid bearing part 230 to form a journal bearing part. In addition, a fluid is introduced between an inner central portion of the outer fluid bearing part 130 and a central portion of the inner fluid bearing part 230 to form a trust bearing part.

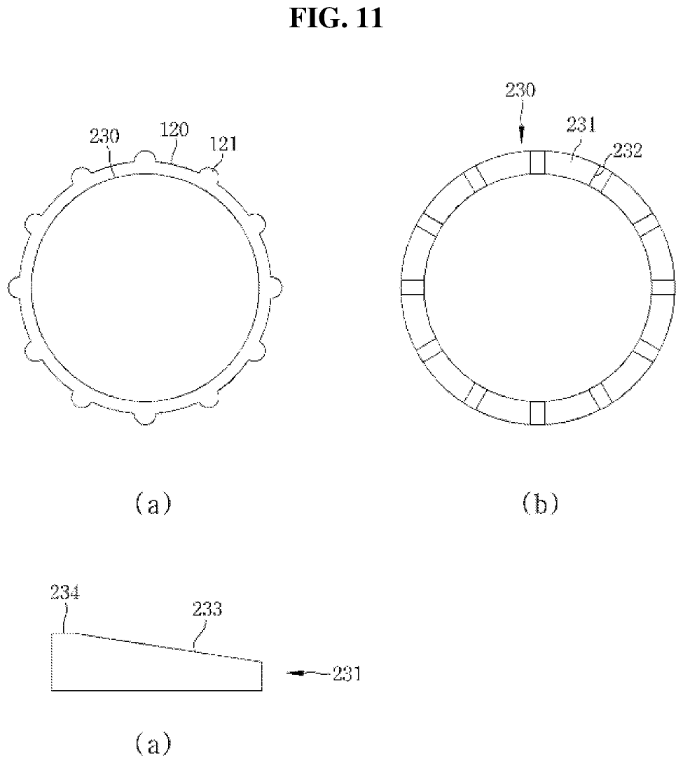

As shown in FIG. 11, oil grooves 121 and 232 may be formed in the inner circumferential surface of the outer fluid bearing part 130 or an upper surface of the inner fluid bearing part 230, and the upper surface of the inner fluid bearing part 230 may form a flat surface and a tapered surface 233, as shown in (c) of FIG. 11, so that a fluid can be diffused from the flat surface to the tapered surface by pressure.

As described above, when the cavitation generator 100 and the Coanda generator 200 are configured to be able to rotate relative to each other, generation of bubble-type cavitation may be maximized to increase generation of microbubbles.

In addition, in a case where a general rolling bearing is used, performance degradation and a decrease in production due to product exchange may be caused because of mixing of foreign substances and wear due to long-term use, but in the fluid supply apparatus 10 according to the second embodiment of the present disclosure, the cavitation generator 100 is supported by being buoyed by the Coanda generator 200 through a fluid, and thus, the fluid supply apparatus 10 can be used semi-permanently and can be prevented from direct contact between the cavitation generator 100 and the Coanda generator 200 even in the event of external shock, preventing product damage.

In addition, in the fluid supply apparatus 10 according to the second embodiment of the present disclosure, the Coanda generator 200 is divided into three modules 200a, 200b, and 200c separated from each other as shown in FIG. 9, and the respective modules 200a, 200b, and 200c are connected to be rotatable relative to each other through bearings 260, so that the respective modules 200a, 200b, and 200c may be configured to rotate in different directions or any one thereof may can be configured to be rotatable. The modules 200a, 200b, and 200c are connected to each other so as to be rotatably connected to each other to increase generation of vortex and turbulence, thereby further improving generation of the Coanda effect.

The Coanda generating protrusions 210 formed in each of the modules 200a, 200b, and 200c may all be formed in the same direction, but as in this embodiment, fluid passages 220 formed between the Coanda generating protrusions 210 of the respective modules 200a, 200b, and 200c may have a structure in which the fluid passages 220 are arranged in a zigzag shape in such a way that Coanda generating protrusions 210 of a first module 200a and a third module 200c are arranged in the same direction while Coanda generating protrusions 210 of a second module 200b disposed in the center are arranged in the opposite direction.

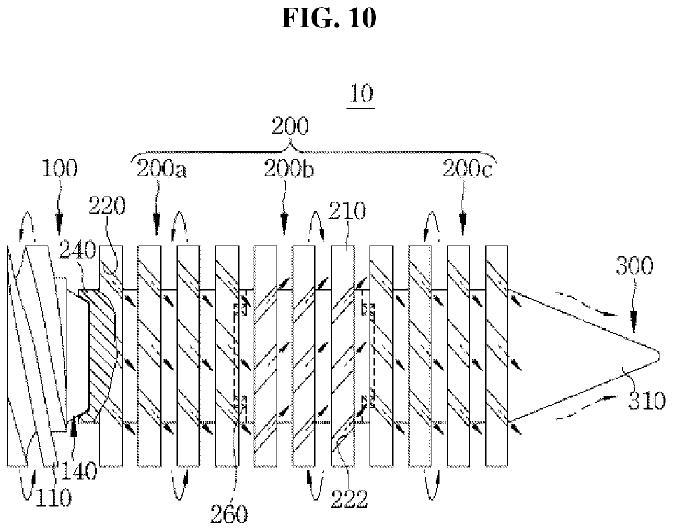

In addition, as shown as a modified example in FIG. 10, a fluid bearing insertion part 140 may be formed at the rear end of the cavitation generator 100 and a fluid bearing receiving part 240 to which the fluid bearing insertion part 140 is connected while being relatively rotatably inserted may be formed at a rear end of the Coanda generator 200, so that the cavitation generator 100 and the Coanda generator 200 can be relatively rotatably connected.

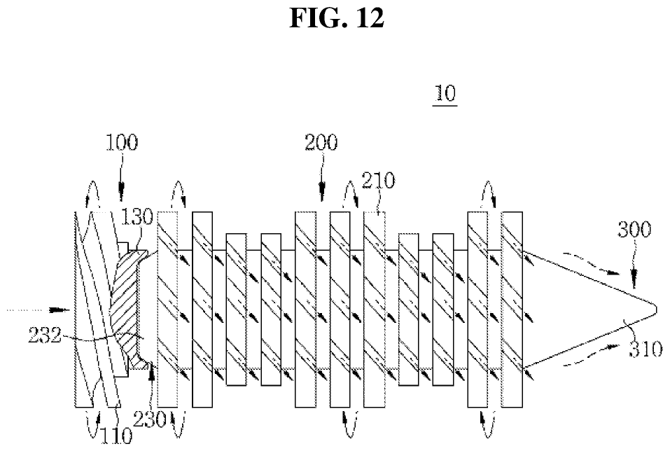

Hereinafter, a third embodiment of the present disclosure will be described. As shown in FIG. 12, in a fluid supply apparatus 10 according to the third embodiment of the present disclosure, Coanda generating protrusions 210 of a Coanda generator 200 are formed to have different heights, so that the Coanda generator 200 is configured to have forms with different diameters. In addition, according to the user's selection, as shown in FIGS. 9 and 10, the Coanda generator 200 may be formed as divided modules and the modules may be configured to be rotatable in different directions or any one of the modules may be configured to be rotatable. In doing so, there is an effect that generation of vortex and turbulence is increased, thereby further improving the Coanda effect.

In the fluid supply apparatus according to the embodiments of the present disclosure, many microbubbles may be formed in a fluid supplied to an object to be processed through the above-described configuration, and the supplied fluid may flow in close contact with any of various shapes and grooves of the object to be processed, and thus, there is an effect of maximizing lubricity of the object to be processed.

Next, the present disclosure intends to improve the user's skin health by applying the fluid supply apparatus 10 according to this embodiment to a shower head.

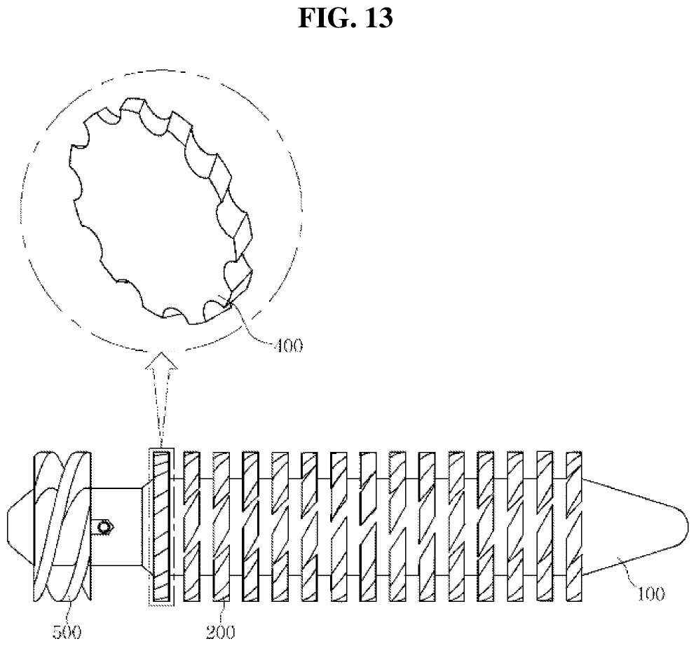

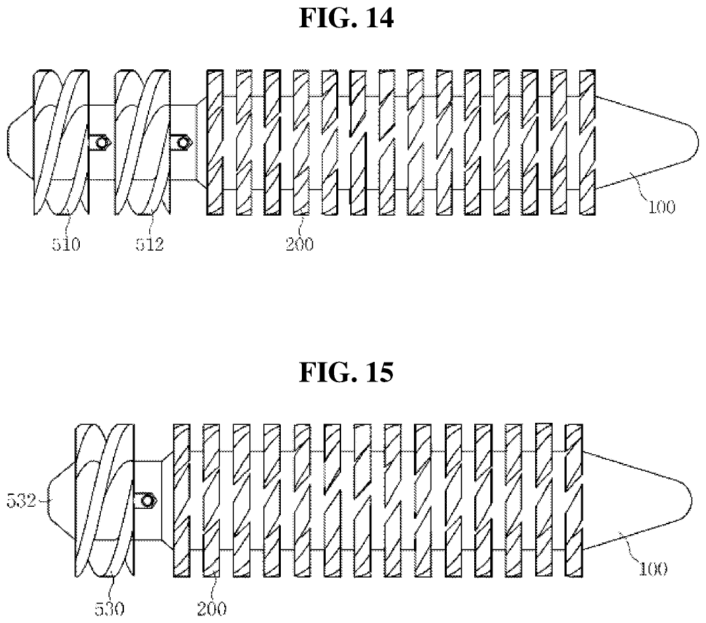

That is, the cavitation effect and the Coanda effect are generated in a fluid supplied through the fluid supply apparatus 10 to stimulate the user's skin surface through microbubbles, thereby removing foreign substances from the user's skin surface and the fluid is allowed to flow along the user's skin surface, thereby enhancing vitality of the user's skin through skin irritation. As shown in FIG. 13, a fluid supply apparatus according to an embodiment of the present disclosure includes a fluid guide groove 400 having therein a concave recess at a rear end of a wing 500 so that a fluid passing through the wing 500 is guided between the Coanda generating protrusions 210.

The fluid guide groove 400 may be formed directly on a surface of the cylindrical Coanda body or may be formed as a separate saw tooth-shaped protrusion.

Next, the fluid supply apparatus according to the embodiment of the present disclosure includes one or more wings 510 and 512 as shown in FIG. 14.

In addition, a convex semicircular or trapezoidal protrusion 532 is formed at a tip of the wing 510, a concave recess is again formed in the center of the protrusion, and a first fluid diffusion part 122 is formed in the center of the concave recess through the center of the wing part 530 and connected to the outer surface of the cylindrical Coanda body.

Next, in the fluid supply apparatus according to the embodiment of the present disclosure, a distance between a protrusion 210 and a rear end protrusion 212 gradually changes, as shown in FIG. 16. Depending on a user's selection, the distance may be formed to be gradually smaller or wider.

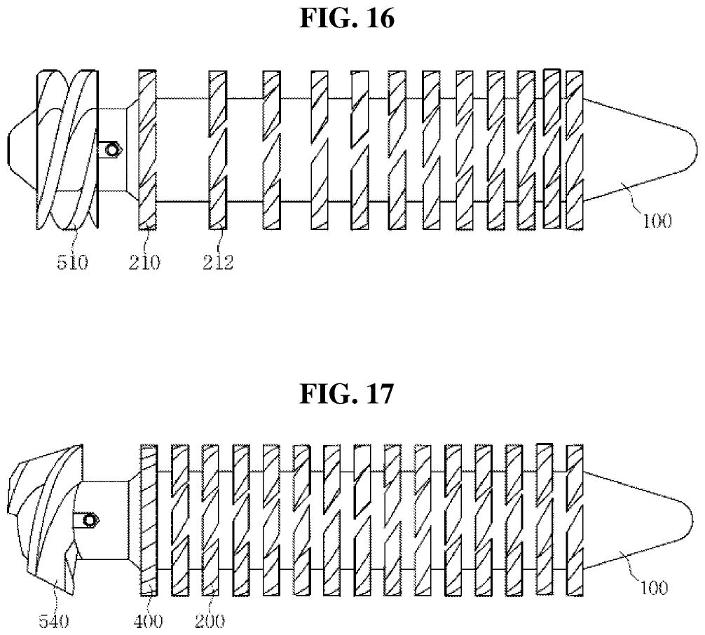

Next, the fluid supply apparatus according to the embodiment of the present disclosure has a tapered shape of a wing 540, as shown in FIG. 17.

Although preferred embodiments of the present disclosure have been described above, various changes, modifications and equivalents may be used in the present disclosure. It is clear that the present disclosure can be equally applied by appropriately modifying the above embodiments. Therefore, the above description is not intended to limit the scope of the present disclosure, which is defined by the limits of the following claims.

A fluid supply apparatus according to the present disclosure may be used in various ways, such as a shower head, as well as a fluid supply apparatus for supplying a fluid to a surface of an object to be processed of a machining apparatus.

1. A fluid supply apparatus for inducing cavitation and Coanda effects, the apparatus comprising:
a cavitation generator configured to allow an introduced fluid to flow while rotating along a propeller-shaped wing so as to generate microbubbles in the fluid; and
a Coanda generator disposed in front of the cavitation generator and having a plurality of Coanda generating protrusions arranged at regular distances so that, as a fluid passing through the cavitation generator to contain microbubbles passes through a passage between the Coanda generating protrusions, a velocity increases and the pressure decreases, thereby causing a Coanda effect in which the fluid flows along a surface of an object,
wherein each of the Coanda generating protrusions has a rhombic cross section, and a length of a transverse central axis of each of the Coanda generating protrusions is 25% to 35% of a length of a longitudinal central axis,
wherein a direction parallel to the longitudinal central axis of each of the Coanda generating protrusions is defined as an x direction, a direction orthogonal to the x direction and parallel to the transverse central axis of each of the Coanda generating protrusions is defined as a y direction, and a direction parallel to any one hypotenuse of each of the Coanda generating protrusions is defined as a z direction,
a distance between Coanda generating protrusions in the y direction is formed at a ratio of 22% to 30% of the length of the longitudinal central axis, and a distance D2 between Coanda generating protrusions in the z direction is formed at a ratio of 36% to 59% of the length of the longitudinal central axis.

2. The fluid supply apparatus of claim 1, wherein a height of each of the Coanda generating protrusions is 32% to 55% of the length of the longitudinal central axis.

3. The fluid supply apparatus of claim 1,
wherein a rear side of the cavitation generator has a forward concave groove shape and induces cavitation and Coanda effects.

4. A fluid supply apparatus for inducing cavitation and Coanda effects, the apparatus comprising:
a cavitation generator configured to allow an introduced fluid to flow while rotating along a propeller-shaped wing so as to generate microbubbles in the fluid; and
a Coanda generator disposed at a rear end of the cavitation generator and configured to allow a velocity to increase as a fluid passing through the cavitation generator to contain microbubbles passes through a passage between the Coanda generating protrusions and to allow the fluid to be discharged through an inclined surface of a fluid supply part so as to reduce pressure of the fluid, thereby causing a Coanda effect in which the fluid flows along a surface of an object;
a first fluid diffusion part configured to allow the fluid, which is introduced to increase a velocity of the fluid passing through the cavitation generator, to pass through a central portion of the cavitation generator and be injected toward an outer circumferential surface of the cavitation generator.

5. The fluid supply apparatus of claim 4, further comprising:
a second fluid diffusion part passing through a rear end of the cavitation generator and communicating with an outer circumferential surface of the Coanda generator to inject the fluid onto the outer circumferential surface of the Coanda generator so as to increase a velocity of the fluid.

6. The fluid supply apparatus of claim 5, wherein the first fluid diffusion part and the second fluid diffusion part communicate with each other, so that a part of a fluid introduced into the first fluid diffusion part is transferred to the second fluid diffusion part and then injected.

7. The fluid supply apparatus of claim 1, wherein a groove-shaped turbulence generator is formed in a rear end of the cavitation generator so as to cause turbulence and vortex in the introduced fluid.

8. The fluid supply apparatus of claim 1, wherein the cavitation generator is connected to the Coanda generator to be rotatable relatively thereto.

9. The fluid supply apparatus of claim 8, wherein a space is formed between the cavitation generator and the Coanda generator, and the fluid forms an oil film in the space by pressure, so that the cavitation generator is supported by being buoyed by the Coanda generator.

10. The fluid supply apparatus of claim 1, wherein the Coanda generator is provided as modules separated from each other and rotatably connected to each other through bearings.

11. The fluid supply apparatus of claim 10, wherein any one of the separated modules of the Coanda generator has a different diameter.
